(19) United States
(12) Patent Application Publication
(10) Pub. No.: US 2023/0292713 A1
(43) Pub. Date: Sep. 21, 2023

(54) Bird Harness and Clasp

(71) Applicant: Tara M. Mibus, Denver, CO (US)

(72) Inventor: Tara M. Mibus, Denver, CO (US)

(21) Appl. No.: 18/123,495

(22) Filed: Mar. 20, 2023

Related U.S. Application Data
(60) Provisional application No. 63/322,088, filed on Mar. 21, 2022.

(51) Int. Cl. A01K 27/00

(52) U.S. Cl. CPC A01K 27/002; A01K 27/003

(57) ABSTRACT

A harness may include a number of straps that may be formed of stainless steel chain and/or other materials and one or more clasps. The clasps may include a barrel that defines an internal aperture and includes threads facing the internal aperture and a hook that includes a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion may connect to the harness when the barrel is uncoupled from the hook and the barrel may couple to the hook by screwing onto the hook while the point travels along the threads.

### CROSS-REFERENCE TO RELATED APPLICATION

This application is a non-provisional of and claims the benefit under 35 U.S.C. 119(e) of U.S. Provisional Patent Application No. 63/322,088, filed Mar. 21, 2022, the contents of which are incorporated herein by reference as if fully disclosed herein.

### FIELD

The described embodiments relate generally to harnesses. More particularly, the present embodiments relate to a bird harness and a clasp.

### BACKGROUND

Many people interact with animals. For example, people may keep animals as pets or livestock and/or may interact with animals kept as pets or livestock as part of their employment. Birds are one example of animals that may be kept as pets or livestock. Interactions with birds may include feeding and/or other care of the bird, taking the bird outside and/or otherwise transporting the bird, and so on.

One or more harnesses may be placed on a bird as part of interacting with the bird. For example, the harness may be placed on the bird and coupled to a leash and/or other mechanism in order to control and/or otherwise restrict the bird's movements, such as to prevent the bird from escaping when taken outside, near an open window or door, and so on.

### Overview

The present disclosure relates to harnesses and/or clasps that are adjustable, durable, and resistant to manipulation by birds or other creatures upon whom the harnesses and/or clasps are used. The harness may include a number of straps (such as a back strap, shoulder straps connected to the back strap, a breastbone strap connected to the shoulder straps, and a tail strap connected to the breastbone strap) that may be formed of stainless steel chain and/or other materials and one or more clasps. The clasps may include a barrel that defines an internal aperture and includes threads facing the internal aperture and a hook that includes a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion may be configured to connect to the harness when the barrel is uncoupled from the hook and the barrel may be configured to couple to the hook by screwing onto the hook while the point travels along the threads.

In various embodiments, a bird harness assembly includes a bird harness and a clasp. The bird harness includes a back strap, shoulder straps connected to the back strap, a breastbone strap connected to the shoulder straps, and a tail strap connected to the breastbone strap. The clasp includes a barrel that defines an internal aperture and includes threads facing the internal aperture and a hook. The hook includes a curved head end portion, a bent head end portion connected to the curved head end portion, a point connected to the bent head end portion, a tail end portion coupled to the tail strap, a curved tail end portion connected to the tail end portion, and a base portion connecting the curved head end portion and the curved tail end portion. The curved head end portion is configured to connect to the bird harness when the barrel is uncoupled from the hook. The barrel is configured to couple to the hook by screwing onto the hook while the point travels along the threads.

In some examples, at least one of the back strap, the shoulder straps, the breastbone strap, and the tail strap is a chain. In a number of implementations of such examples, the chain is made of steel.

In various examples, the bird harness assembly further includes a ring connected to the back strap.

In some examples, the tail end portion is a point or a stopper.

In a number of examples, the bird harness assembly further includes a leash connected to the breastbone strap and the tail strap. In various implementations of such examples, the bird harness assembly further includes a leash loop connected to the leash.

In some embodiments, a bird harness assembly includes a bird harness and a clasp coupled to the bird harness. The clasp includes a barrel that defines an internal aperture and includes threads facing the internal aperture and a hook. The hook includes a curved head end portion, a bent head end portion connected to the curved head end portion, a point connected to the bent head end portion, a tail end portion, a curved tail end portion connected to the tail end portion, and a base portion connecting the curved head end portion and the tail end portion. The curved head end portion and the curved tail end portion are each configured to connect to the bird harness when the barrel is uncoupled from the hook. The barrel is configured to couple to the hook by screwing onto the hook while the point travels along the threads.

In various examples, the curved tail end portion is configured to connect to the bird harness by connecting to a strap of the bird harness and operable to position the strap away from the threads. In some examples, the curved head end portion cooperates with the barrel to prevent the point that is travelling along the threads from travelling all the way through the internal aperture. In a number of examples, the bent head end portion includes a bend that is positioned closer to the base portion than a first portion of the bent head end portion that connects to the curved head end portion and a second portion of the bent head end portion that connects to the point. In various examples, the hook is formed of a unitary metal wire. In some examples, the tail end portion resists disconnection of the bird harness from the hook other than from the point.

In a number of embodiments, a clasp for a bird harness includes a barrel that defines an internal aperture and includes threads facing the internal aperture and a hook. The hook includes a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion and the curved tail end portion are each configured to connect to the bird harness when the barrel is uncoupled from the hook. The barrel is configured to couple to the hook by screwing onto the hook while the point travels along the threads.

In various examples, the tail end portion is a coil or a point. In some examples, the barrel resists removal of the bird harness from the curved head end portion and the curved tail end portion while the curved head end portion and the curved tail end portion are connected to the bird harness and the barrel is coupled to the hook. In a number of examples, the point is operable to travel along the threads all the way through the internal aperture. In various examples, the curved head end portion is larger than the internal aperture. In some examples, the barrel is operable to at least partially surround the tail end portion when the barrel is coupled to the hook. In a number of examples, part of the curved head end portion is smaller than the internal aperture.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a top view of a first example bird harness with example first and second clasps.

FIG. 1B depicts the bird harness of FIG. 1A after a bird has been placed over the bird harness.

FIG. 1C depicts the bird harness of FIG. 1B after the bird harness is positioned over the head of the bird such that the back strap is positioned over the back of the bird.

FIG. 1D depicts the bird harness of FIG. 1C after the first clasp is attached to the beaded ring.

FIG. 1E depicts the bird harness of FIG. 1D after the second clasp is attached to the beaded ring.

FIG. 1F depicts the bird harness of FIG. 1E after the first and second clasps are moved to attach to the back strap.

FIG. 1G depicts the bird harness of FIG. 1E after the leash loop is connected to a carabiner that is coupled to a lanyard on a user's neck.

FIG. 1H depicts the bird harness of FIG. 1E after the leash loop is placed on a hand of a user.

FIG. 1I depicts the bird harness of FIG. 1E after the leash loop is connected to a carabiner that is coupled to a wrist strap on a user's wrist.

FIG. 2A depicts a top view of a second example clasp that may be used with a bird harness, such as the bird harness of FIGS. 1A-1I, the bird harness of FIGS. 6A-6C, and/or the bird harness of FIGS. 9A-9O.

FIG. 2B depicts a cross-sectional view of the clasp of FIG. 2A, taken along the line A-A.

FIG. 3A depicts a top view of the hook of the clasp of FIG. 2A removed from the barrel.

FIG. 3B depicts a bottom view of the hook of FIG. 3A.

FIG. 3C depicts a front side view of the hook of FIG. 3A.

FIG. 3D depicts a left side view of the hook of FIG. 3B.

FIG. 4A depicts a top view of the barrel of the clasp of FIG. 2A removed from the hook.

FIG. 4B depicts an isometric right view of the barrel of FIG. 4A.

FIG. 5A depicts the hook and barrel of FIG. 4A uncoupled from each other.

FIG. 5B depicts FIG. 5A after one of the ends of the tail strap of the bird harness of FIGS. 1A-1I is pulled through the internal aperture defined by the barrel.

FIG. 5C depicts FIG. 5B after the tail strap is coupled to the hook.

FIG. 5D depicts FIG. 5C after the beaded ring of the bird harness of FIGS. 1A-1I is positioned adjacent the hook.

FIG. 5E depicts FIG. 5D after the beaded ring is coupled to the hook.

FIG. 5F depicts FIG. 5E after the barrel is coupled to the hook.

FIG. 5G depicts FIG. 5F after the barrel is moved on the hook until the point moves all the through the barrel.

FIG. 6A depicts a bird harness like the bird harness of FIG. 1A with the first and second clasps each replaced with a clasp like the clasp of FIG. 5G.

FIG. 6B depicts the bird harness of FIG. 6A with the first and second clasps moved to interior portions of the tail strap.

FIG. 6C depicts the bird harness of FIG. 6A with portions of the tail strap extending past the first and second clasps removed.

FIG. 7 depicts a flow chart illustrating a first example method for attaching a bird harness to a bird. This method may be performed using the bird harness of FIGS. 1A-1I and/or the bird harness of FIGS. 6A-C and/or the clasp of FIG. 2A and/or FIGS. 5F-5G.

FIG. 8 depicts a flow chart illustrating a second example method for connecting straps of a bird harness to a clasp. This method may be performed using the bird harness of FIGS. 1A-1I and/or 6A-6C and/or the clasp of FIG. 2A and/or FIGS. 5F-5G.

FIGS. 9A-9O depict a second example bird harness.

FIG. 10 depicts a flow chart illustrating a third example method for attaching a bird harness to a bird. This method may be performed using the bird harness of 9A-9O.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and apparatuses that embody various elements of the present disclosure. However, it should be understood that the described disclosure may be practiced in a variety of forms in addition to those described herein.

Harnesses that may be used with birds may include cloth straps that go over the bird's head and buckle to a cloth strap that goes around the bird's waist. However, such harnesses may not provide the narrow, minimal straps that are really needed for the small frame and delicate skin of birds, resulting in an uncomfortable harness. Further, birds are dexterous and may be able to unfasten the buckles, chew through the straps, and so on. Any of these factors may cause such harnesses to be unsuitable, and result in people taking their birds outside for needed outdoor exposure much less often than they otherwise would.

The following disclosure relates to harnesses and/or clasps that are adjustable, durable, and resistant to manipulation by birds or other creatures upon whom the harnesses and/or clasps are used. The harness may include a number of straps (such as a back strap, shoulder straps connected to the back strap, a breastbone strap connected to the shoulder straps, and a tail strap connected to the breastbone strap) that may be formed of stainless steel chain and/or other materials and one or more clasps. The clasps may include a barrel that defines an internal aperture and includes threads facing the internal aperture and a hook that includes a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion may be configured to connect to the harness when the barrel is uncoupled from the hook and the barrel may be configured to couple to the hook by screwing onto the hook while the point travels along the threads.

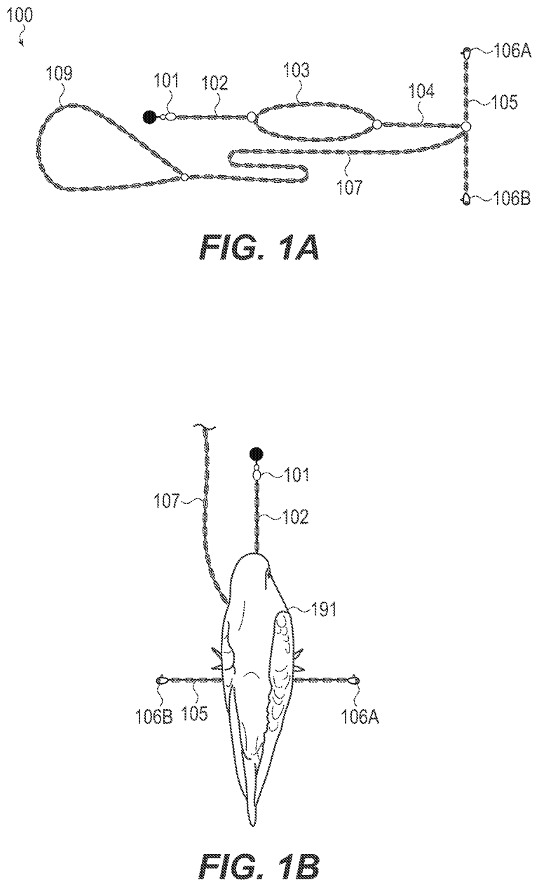

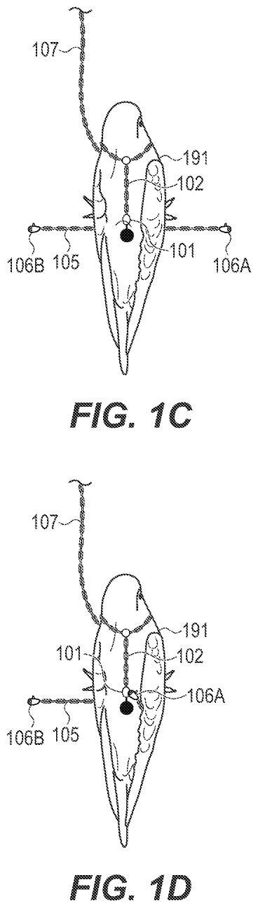

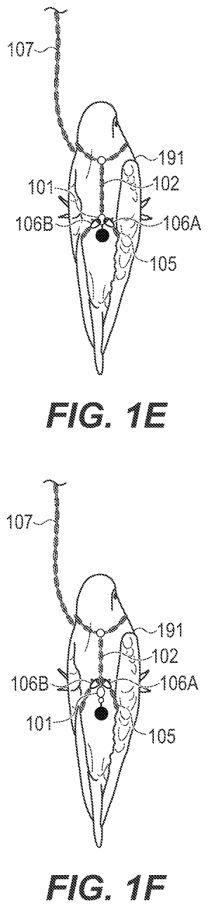

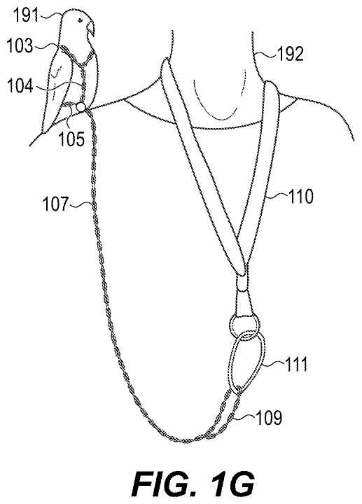

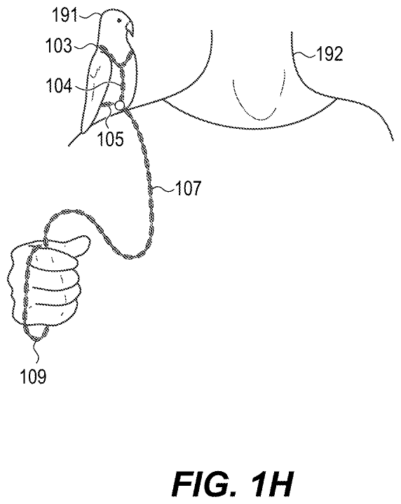

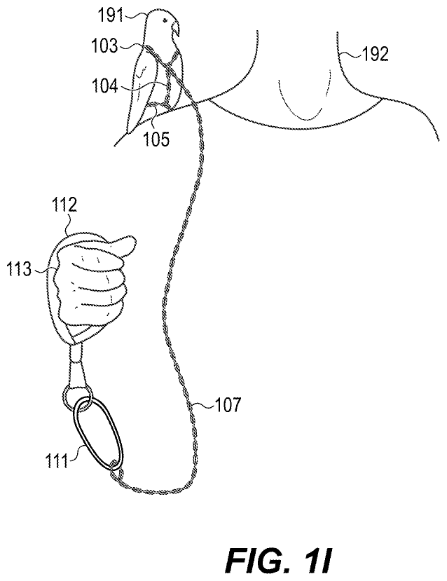

These and other embodiments are discussed below with reference to FIGS. 1A-9O. However, those skilled in the art will readily appreciate that the detailed description given herein with respect to these Figures is for explanatory purposes only and should not be construed as limiting.

FIG. 1A depicts a top view of a first example bird harness 100 with example first and second clasps 106A and 106B. The bird harness 100 may include a number of straps. The straps may be formed of stainless steel chain and/or other materials, such as cords, fabric, wire, steel, iron, carbon fiber, polymer, titanium, aluminum, and so on. The chain may enable the first and second clasps 106A and 106B to be attached at multiple points, increasing the adjustability of the bird harness 100. The chain may be interspersed with one or more beads, rings, and/or other components. Being formed of stainless steel may prevent and/or resist the straps from being chewed through by birds, as well as being non-toxic (such as zinc or other materials may be) to the birds.

The straps may include a back strap 102, shoulder straps 103 connected to the back strap 102, a breastbone strap 104 connected to the shoulder straps 103, and a tail strap 105 connected to the breastbone strap 104. The bird harness 100 may also include a beaded ring 101 coupled to the back strap 102, a leash 107 connected to the breastbone strap 104, a leash loop 109 connected to the leash 107, and/or other components.

FIG. 1B depicts the bird harness 100 of FIG. 1A after a bird 191 has been placed over the bird harness 100. FIG. 1C depicts the bird harness 100 of FIG. 1B after the bird harness 100 is positioned over the head of the bird 191 such that the back strap 102 is positioned over the back of the bird 191. FIG. 1D depicts the bird harness 100 of FIG. 1C after the first clasp 106A is attached to the beaded ring 101. FIG. 1E depicts the bird harness 100 of FIG. 1D after the second clasp 106B is attached to the beaded ring 101.

FIG. 1F depicts the bird harness 100 of FIG. 1E after the first and second clasps 106A and 106B are moved to attach to the back strap 102. By being able to be attached at multiple points, the first and second clasps 106A and 106B increase the adjustability of the bird harness 100.

FIG. 1G depicts the bird harness 100 of FIG. 1E after the leash loop 109 is connected to a carabiner 111 that is coupled to a lanyard 110 on a user's neck. FIG. 1H depicts the bird harness 100 of FIG. 1E after the leash loop 109 is placed on a hand of a user 192. FIG. 1I depicts the bird harness 100 of FIG. 1E after the leash loop 109 is connected to a carabiner 111 that is coupled to a wrist strap 112 on a user's wrist 113.

Although the bird harness 100 is illustrated and described as including particular components arranged in a particular configuration, it is understood that this is an example. In a number of implementations, various configurations of various components may be used without departing from the scope of the present disclosure.

For example, the bird harness 100 is illustrated and described as including a single tail strap 105. However, it is understood that this is an example. In various implementations, the bird harness 100 may include multiple tail straps 105. Various configurations are possible and contemplated without departing from the scope of the present disclosure.

Further, in some implementations, the bird harness 100 may include components other than those shown. By way of illustration, in some examples, the chain may be covered with a cover formed of fabric and/or another material. Various configurations are possible and contemplated without departing from the scope of the present disclosure.

Moreover, the above illustrates and describes the bird harness 100 as being used for birds. However, it is understood that this is an example. In various implementations, the bird harness 100 may be used with creatures other than birds. Various configurations are possible and contemplated without departing from the scope of the present disclosure.

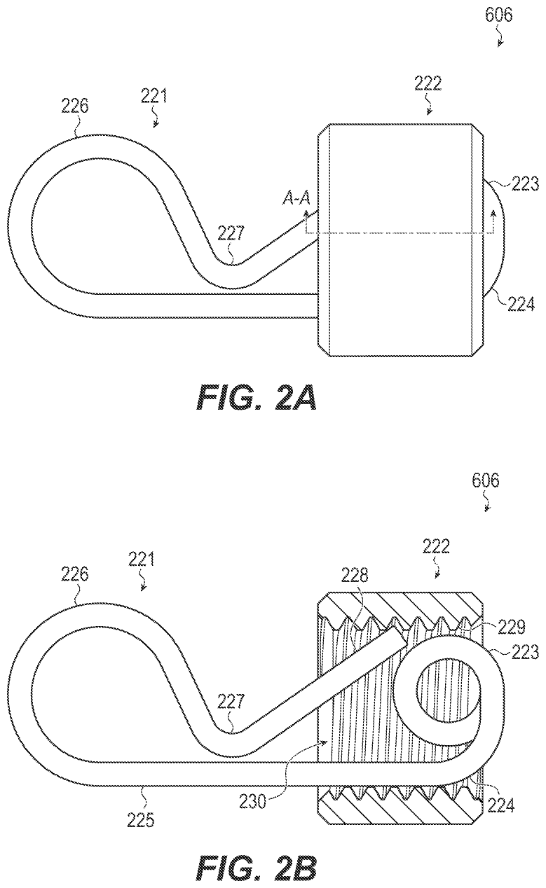

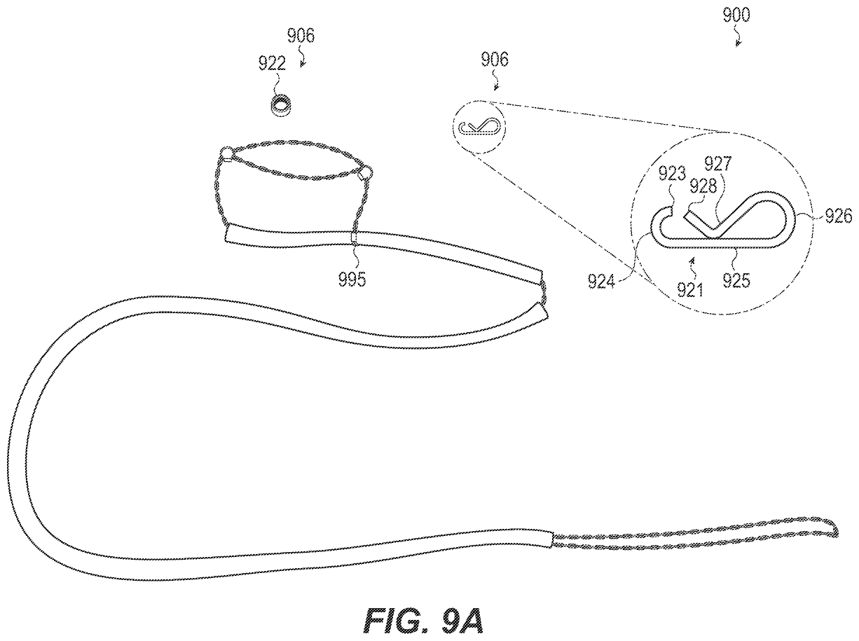

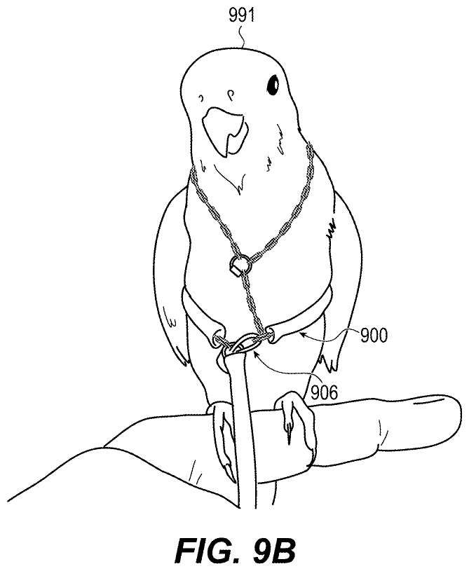

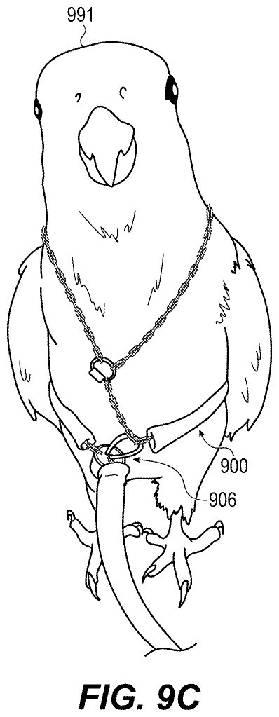

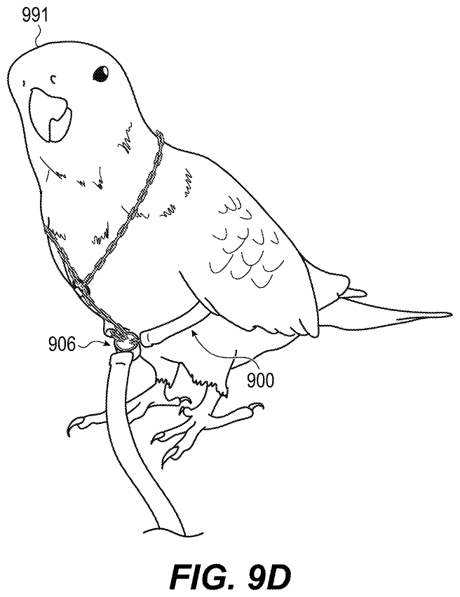

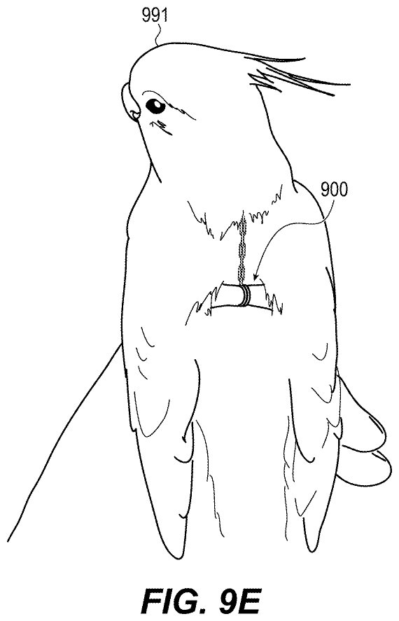

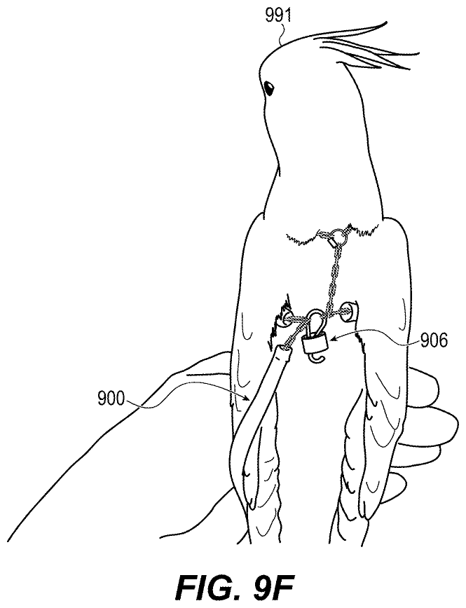

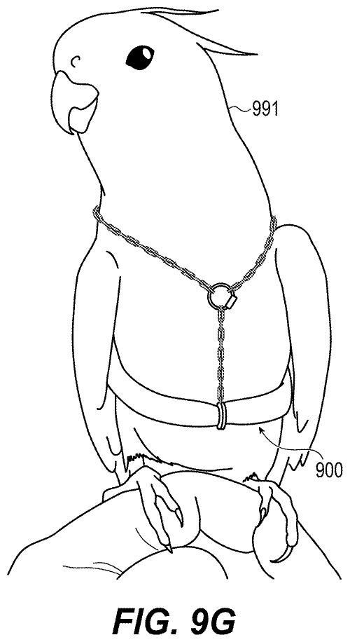

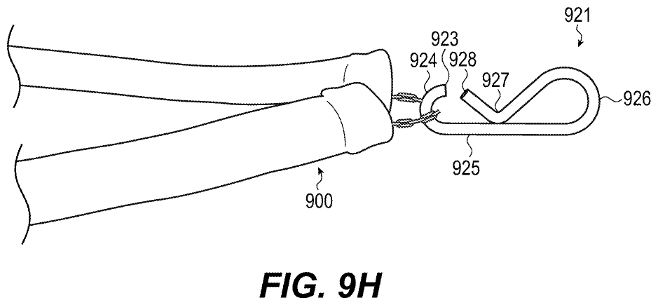

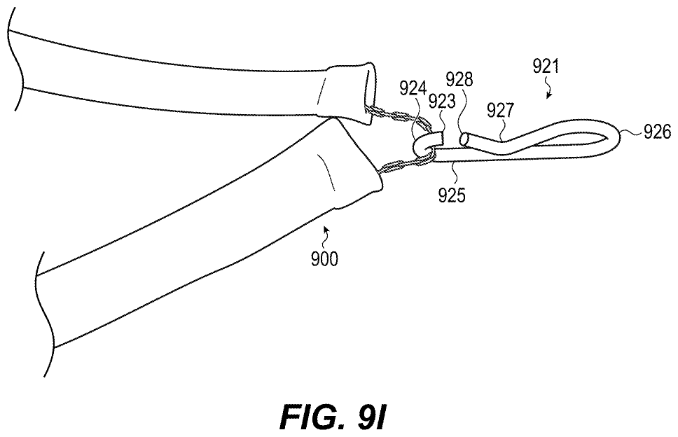

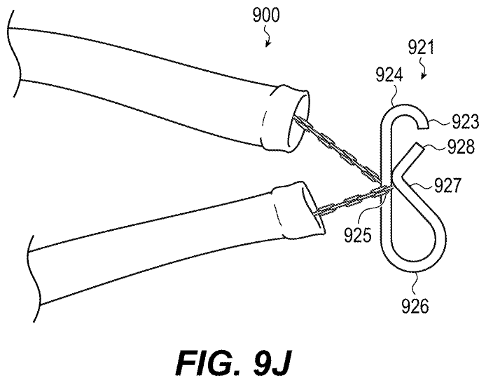

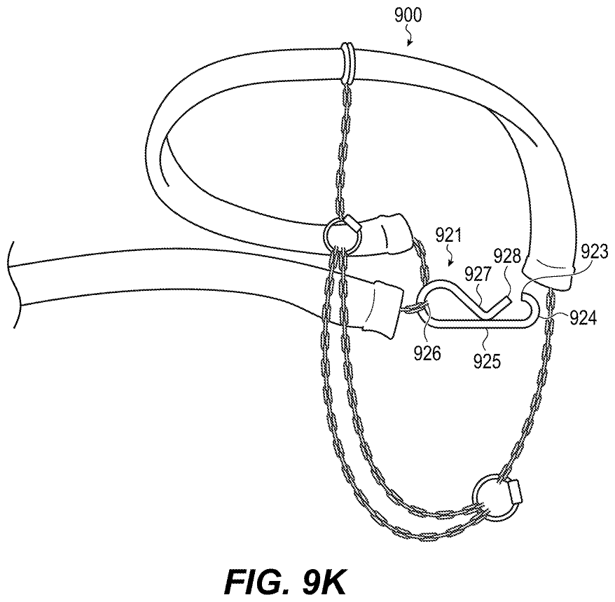

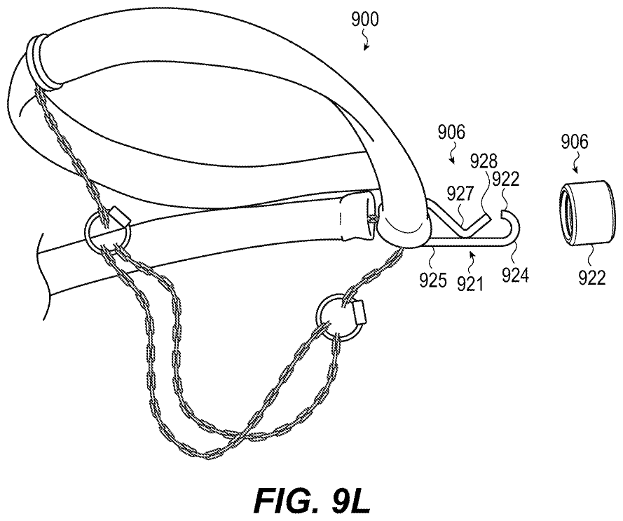

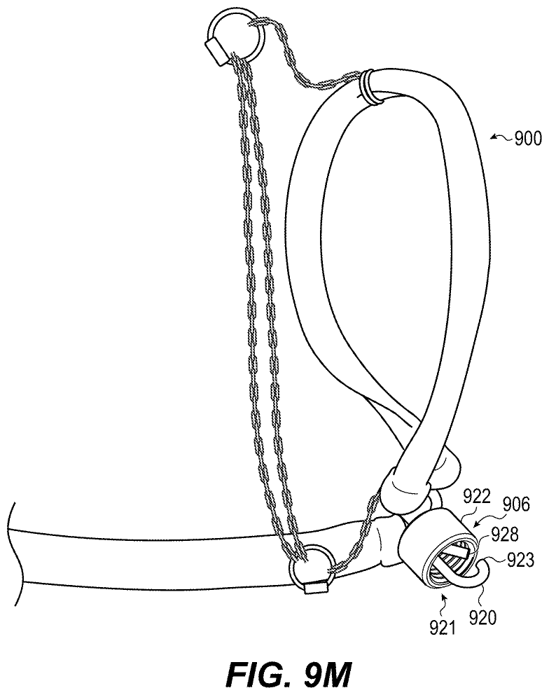

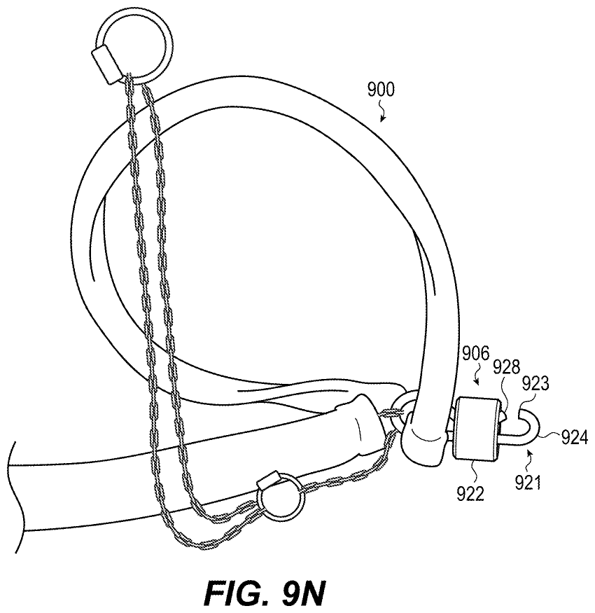

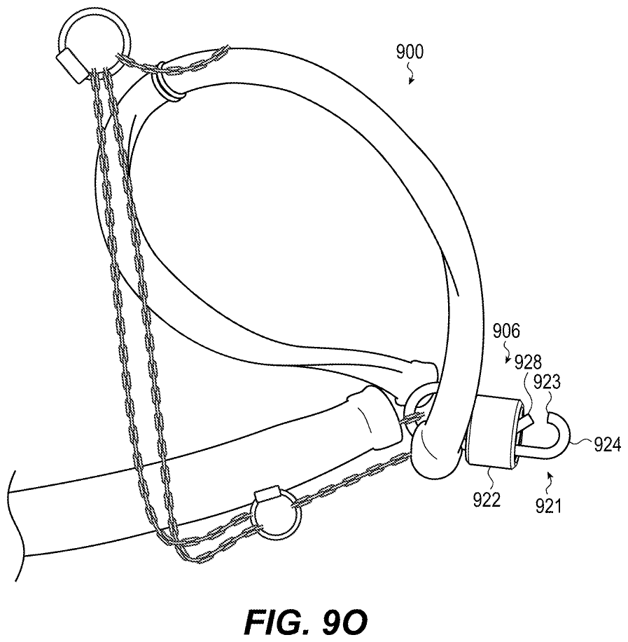

Additionally, the first and second clasps 106A and 106B are illustrated as lobster clasps. However, it is understood that this is an example. In various implementations, other clasps (such as the clasps 606 illustrated and described with respect to FIGS. 2A-6 and/or the clasp 906 illustrated and described with respect to FIGS. 9A-9O) may be used. Various configurations are possible and contemplated without departing from the scope of the present disclosure.

By way of illustration, birds may be able to manipulate lobster clasps. Other clasps, such as the clasps 606 illustrated and described with respect to FIGS. 2A-6 the clasp 906 illustrated and described with respect to FIGS. 9A-9O, may be resistant to manipulation by birds.

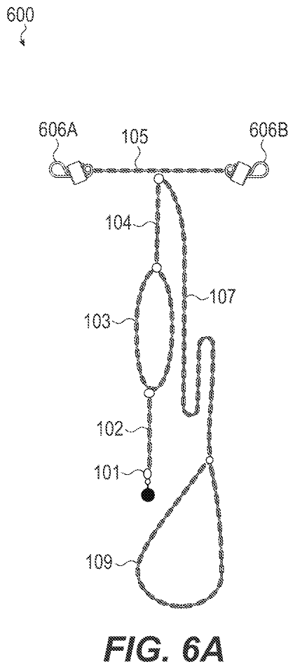

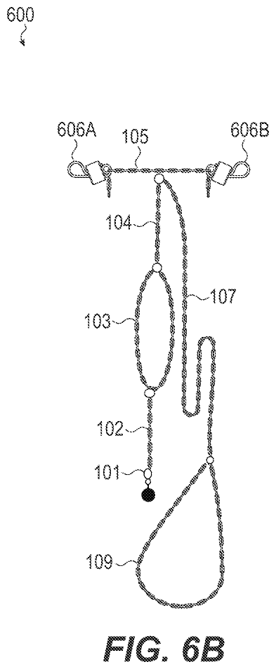

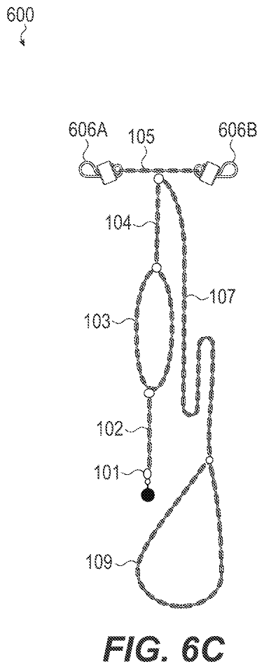

FIG. 2A depicts a top view of a second example clasp 606 that may be used with a bird harness, such as the bird harness 100 of FIGS. 1A-1I, the bird harness 600 of FIGS. 6A-6C, and/or the bird harness 900 of FIGS. 9A-9O. FIG. 2B depicts a cross-sectional view of the clasp 606 of FIG. 2A, taken along the line A-A.

With respect to FIGS. 2A and 2B, the clasp 606 may include a barrel 222 that defines an internal aperture 230 and includes threads 229 facing the internal aperture 230 and a hook 221 that includes a curved head end portion 226, a bent head end portion 227 connected to the curved head end portion 226, a point 228 connected to the bent head end portion 227, a tail end portion 223, a curved tail end portion 224 connected to the tail end portion 223, and a base portion 225 connecting the curved head end portion 226 and the curved tail end portion 224. The bent head end portion 227 includes a bend that is positioned closer to the base portion 225 than a first portion of the bent head end portion 227 that is connected to the curved head end portion 226 and a second portion of the bent head end portion 227 that connects to the point 228.

The curved head end portion 226 is shown as larger than the internal aperture 230. This may prevent the barrel 222 from passing entirely over the hook 221. However, it is understood that this is an example. In other implementations, the curved head end portion 226 may be smaller than the internal aperture 230 and/or may be sized such that the barrel 222 may pass partially over the curved head end portion 226. Various configurations are possible and contemplated without departing from the scope of the present disclosure.

The curved head end portion 226 may be configured to connect to a harness (such as the bird harness 100 of FIGS. 1A-1I, the bird harness 600 of FIGS. 6A-C, and/or the bird harness 900 of FIGS. 9A-9O) and/or other component when the barrel 222 is uncoupled from the hook 221 and the barrel 222 may be configured to couple to the hook 221 by screwing onto the hook 221 while the point 228 travels along the threads 229.

As shown, the point 228 and the tail end portion 223 may cooperate to define a gap that may be exposed when the barrel 222 is not coupled to the hook 221 and may be blocked (resisted by the barrel 222) by the barrel 222 when the barrel 222 is coupled to the hook 221. As such, components like links of a chain may be slid onto the hook 221 via that gap when the barrel 222 is not coupled to the hook 221 and may be blocked (resisted by the barrel 222) from being slid onto the hook 221 via that gap when the barrel 222 is coupled to the hook 221. Further components like links of a chain positioned on the hook may be removed from the hook 221 via that gap when the barrel 222 is not coupled to the hook 221 and may be blocked (resisted by the barrel 222) from being removed from the hook 221 via that gap when the barrel 222 is coupled to the hook 221. In this way, the clasp 606 may function to connect components while being more resistant to manipulation by birds than the clasps 106A and 106B of FIGS. 1A-1F.

As illustrated, the tail end portion 223 is a coil and/or other stopper. Such a coil and/or other stopper may be simpler to manufacture on the hook 221 (particularly when the hook 221 is formed of a unitary material, such as a metal wire or other component) than other components. However, it is understood that this is an example. The coil and/or other stopper may function to stop or resist travel of a chain or other component of a harness traveling along the hook 221 such that the chain or other component of a harness may only be disconnected from the point 228. In various implementations, the tail end portion 223 may be other components capable of performing a stopping function, such as a ball, a flange, and so on. However, in still other examples (see FIGS. 9A-9O), the tail end portion 223 may be other components that do not perform a stopping function. Various configurations are possible and contemplated without departing from the scope of the present disclosure.

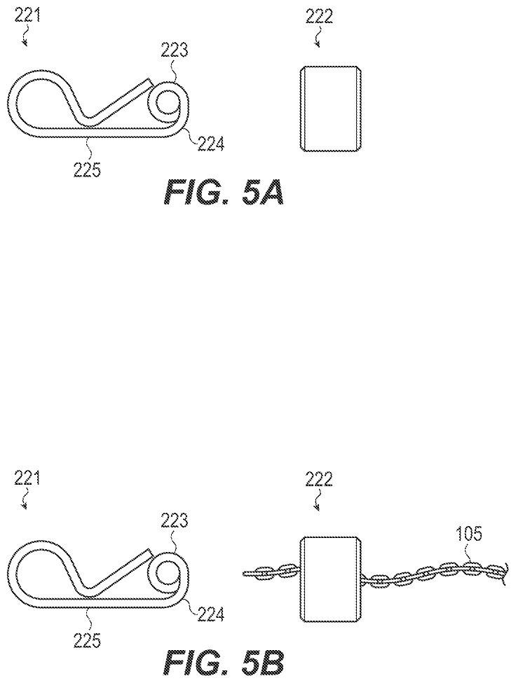

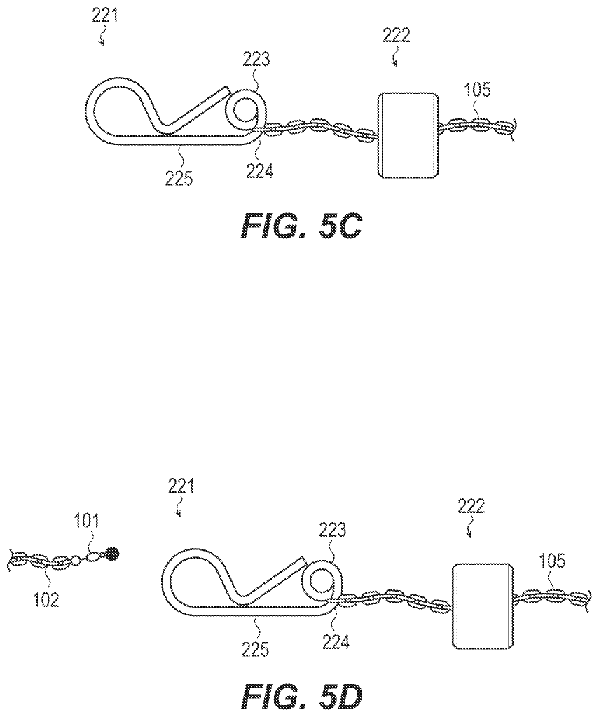

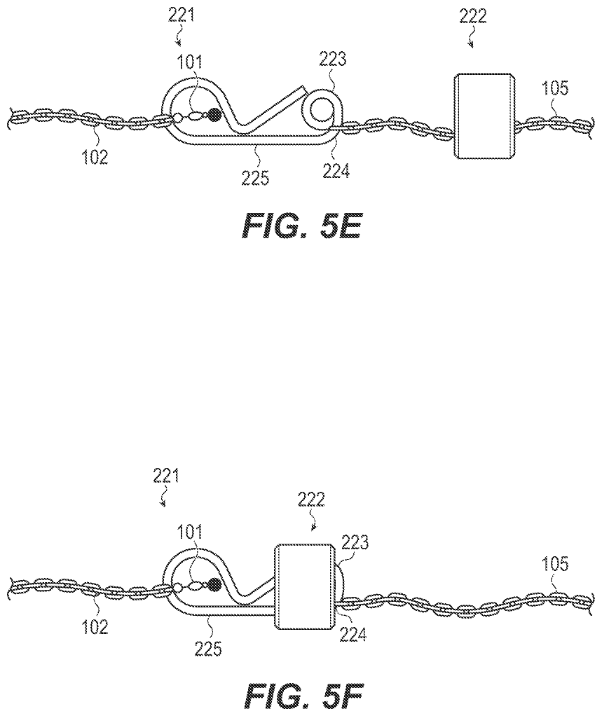

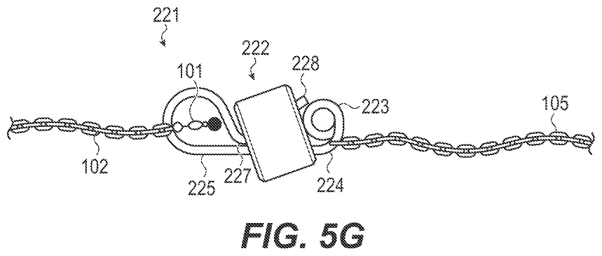

As shown, the barrel 222 may be centered with respect to the hook 221 while the point 228 moves along and/or engages the threads 229. The hook 221 and/or the barrel 222 may also be configured such that the point 228 may move along the threads 229 all the way from a first side of the internal aperture 230 through a second side of the internal aperture 230 and the barrel 222 (such as is shown in FIG. 5G). This may enable the barrel 222 to be tilted (and/or non-centered) with respect to the hook 221 while the barrel 222 is coupled to the hook 221. In this way, the clasp 606 may be more resistant to manipulation by birds as the barrel 222 may need to be un-tilted (and/or centered) with respect to the hook 221 prior to uncoupling of the barrel 222 from the hook 221.

For example, the length of the point 228 may allow the point 228 to travel along the threads 229 until the point 228 moves all the way from a first side of the internal aperture 230 through a second side of the internal aperture 230 and the barrel 222. By way of another example, an angle of the bend of the bent head end portion 227 may allow the point 228 to travel along the threads 229 until the point 228 moves all the way from a first side of the internal aperture 230 through a second side of the internal aperture 230 and the barrel 222. In still another example, a size of at least part of the curved head end portion 226 may be small enough with respect to the internal aperture 230 that the barrel 222 does not prevent and/or resist the point 228 from travelling along the threads 229 until the point 228 moves all the way from a first side of the internal aperture 230 through a second side of the internal aperture 230 and the barrel 222. Various configurations are possible and contemplated without departing from the scope of the present disclosure.

However, it is understood that this is an example. In other implementations, various components of the hook 221 and/or the barrel 222 (such as the length of the point 228, an angle of the bend of the bent head end portion 227, a size of at least part of the curved head end portion 226, and so on) may prevent the point 228 from moving along the threads 229 all the way from a first side of the internal aperture 230 through a second side of the internal aperture 230 and the barrel 222 whereupon the barrel 222 may partially and/or fully surround the tail end portion 223. In such implementations, the barrel 222 may not be able to be tilted (and/or non-centered) with respect to the hook 221 while the barrel 222 is coupled to the hook 221.

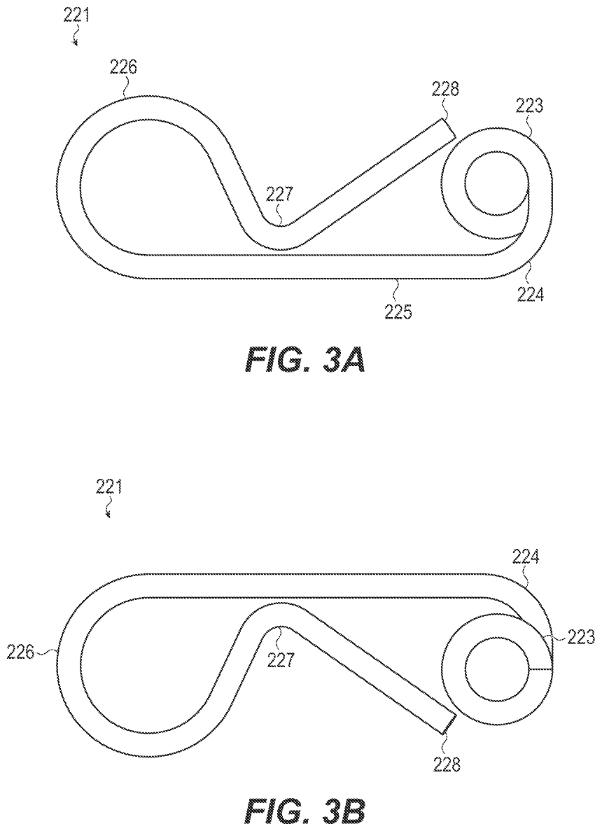

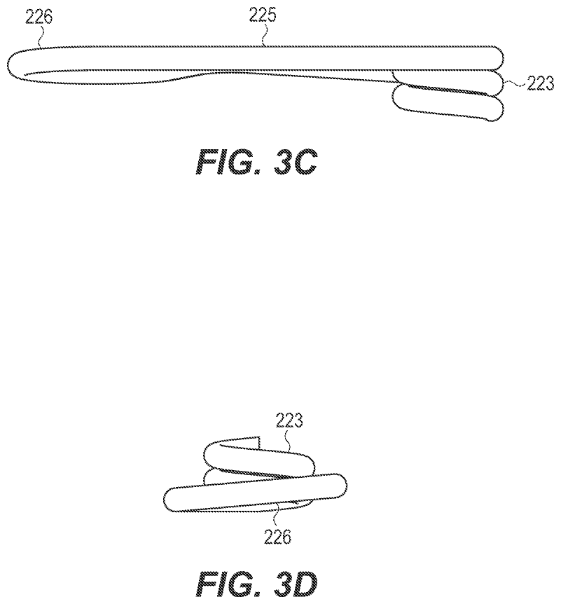

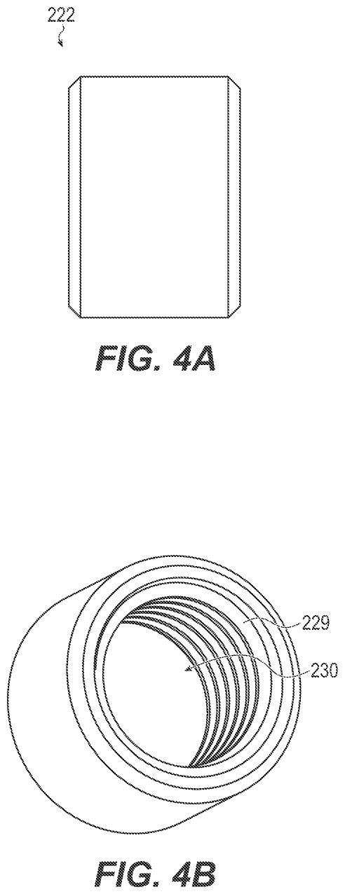

FIG. 3A depicts a top view of the hook 221 of the clasp 606 of FIG. 2A removed from the barrel 222. FIG. 3B depicts a bottom view of the hook 221 of FIG. 3A. FIG. 3C depicts a front side view of the hook 221 of FIG. 3A. FIG. 3D depicts a left side view of the hook 221 of FIG. 3B. FIGS. 3A-3D respectively illustrate the curved head end portion 226, the bent head end portion 227, the point 228, the tail end portion 223, the curved tail end portion 224, and the base portion 225.

FIG. 4A depicts a top view of the barrel 222 of the clasp 606 of FIG. 2A removed from the hook 221. FIG. 4B depicts an isometric right view of the barrel 222 of FIG. 4A. FIG. 4B illustrates the threads 229 and the internal aperture 230 extending from a first side of the barrel 222 to a second side of the barrel.

FIG. 5A depicts the hook 221 and the barrel 222 of FIG. 4A uncoupled from each other. FIG. 5B depicts FIG. 5A after one of the ends of the tail strap 105 of the bird harness 100 of FIGS. 1A-1I is pulled through the internal aperture (shown in FIGS. 2B and 4B) defined by the barrel 222. FIG. 5C depicts FIG. 5B after the tail strap 105 is coupled to the hook 221. FIG. 5D depicts FIG. 5C after the beaded ring 101 of the bird harness 100 of FIGS. 1A-1I is positioned adjacent the hook 221. FIG. 5E depicts FIG. 5D after the beaded ring 101 is coupled to the hook 221. FIG. 5F depicts FIG. 5E after the barrel 222 is coupled to the hook 221. FIG. 5G depicts 5F after the barrel 222 is moved on the hook 221 until the point 228 moves all the way through the barrel 222.

As such, the tail strap 105 and/or the beaded ring 101 may be slid onto the hook 221 when the barrel 222 is not coupled to the hook 221 and may be blocked (resisted by the barrel 222) from being slid onto the hook 221 when the barrel 222 is coupled to the hook 221. Further the tail strap 105 and/or the beaded ring 101 may be removed from the hook 221 when the barrel 222 is not coupled to the hook 221 and may be blocked (resisted by the barrel 222) from being removed from the hook 221 when the barrel 222 is coupled to the hook 221. In this way, the clasp 606 may function to connect the tail strap 105 and the beaded ring 101 while being more resistant to manipulation by birds than the clasps 106A and 106B of FIGS. 1A-1F.

As shown in FIGS. 5C-5F, the curved tail end portion 224 functions to position the tail strap 105 away from the threads 229 (shown in FIGS. 2B and 4B) of the barrel 222. If the tail end portion 223 were directly connected to the base portion 225, the tail strap 105 positioned at the tail end portion 223 could become ground by the threads 229 (shown in FIGS. 2B and 4B) of the barrel 222, potentially damaging the tail strap 105 and/or the barrel 222. However, as the curved tail end portion 224 functions to position the tail strap 105 away from the threads 229 (shown in FIGS. 2B and 4B) of the barrel 222, the curved tail end portion 224 prevents such potential damage.

FIG. 6A depicts a bird harness 600 like the bird harness 100 of FIG. 1A with the first and second clasps 106A and 106B each replaced with first and second clasps 606A and 606B like the clasp 606 of FIG. 5G. FIG. 6B depicts the bird harness of FIG. 6A with the first and second clasps 606A and 606B moved to interior portions of the tail strap 105. FIG. 6C depicts the bird harness of FIG. 6A with portions of the tail strap 105 extending past the first and second clasps 606A and 606B removed. In this way, the first and second clasps 606A and 606B can be removed from the tail strap 105 and moved anywhere up or down the tail strap 105, whereupon any excess portions of the tail strap 105 may be removed, increasing adjustability and enhancing fit of the bird harness 600.

The above illustrates and describes the clasp 606 of FIG. 5G being used with the bird harness 600. However, it is understood that this is an example. In various implementations, the clasp 606 of FIG. 5G may be used to clasp components other than the bird harness 600, other bird harnesses, other harnesses, and so on. Various configurations are possible and contemplated without departing from the scope of the present disclosure.

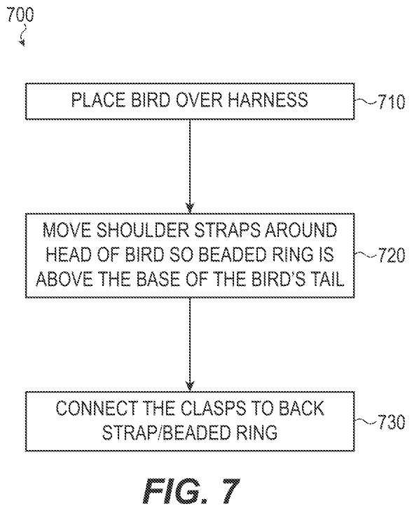

FIG. 7 depicts a flow chart illustrating a first example method for attaching a bird harness to a bird. This method may be performed using the bird harness 100 of FIGS. 1A-1I and/or the bird harness 600 of FIGS. 6A-C and/or the clasp 606 of FIG. 2A and/or FIGS. 5F-G.

At operation 710, a bird is placed over a harness. At operation 720, shoulder straps of the harness are moved around the head of the bird so that a beaded ring of the harness is above the base of the bird's tail. At operation 730, one or more clasps of the harness are connected to a back strap of the harness and/or the beaded ring.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as connecting one or more clasps of the harness to the back strap of the harness and/or the beaded ring. However, this is an example. In various implementations, one or more clasps may be coupled to other components of the harness. Various configurations are possible and contemplated without departing from the scope of the present disclosure.

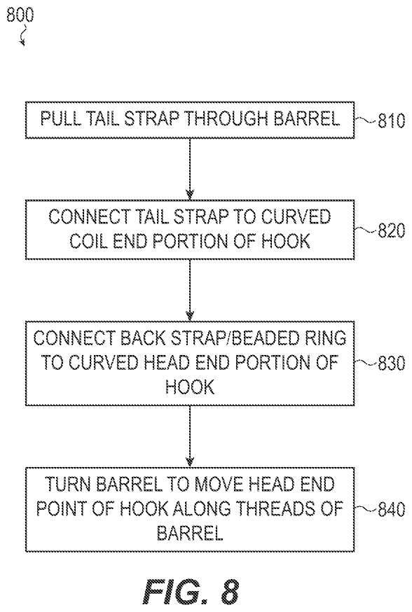

FIG. 8 depicts a flow chart illustrating a second example method 800 for connecting straps of a bird harness to a clasp. This method 800 may be performed using the bird harness 100 of FIGS. 1A-1I and/or the bird harness 600 of FIGS. 6A-C and/or the clasp 606 of FIG. 2A and/or FIGS. 5F-G.

At operation 810, a tail strap of a harness is pulled through a barrel of a clasp. At operation 820, the tail strap is connected to a curved coil end portion of a hook of the clasp. At operation 830, a back strap and/or a beaded ring of the harness is connected to a curved head end portion of the hook. At operation 840, the barrel is turned to move a head end point of the hook along threads of the barrel.

Although the example method 800 is illustrated and described as including particular operations performed in a particular order, it is understood that this is an example. In various implementations, various orders of the same, similar, and/or different operations may be performed without departing from the scope of the present disclosure.

For example, the method connects the clasp to the tail strap, the back strap, and/or the beaded ring of the harness. However, this is an example. In various implementations, other portions of the harness than the tail strap, the back strap, and/or the beaded ring may be connected to the clasp. Various configurations are possible and contemplated without departing from the scope of the present disclosure.

FIGS. 9A-9O depict a second example bird harness 900. The bird harness 900 may be like the bird harness 100 of FIG. 1A and/or the bird harness 600 of FIG. 6. Contrasted with the bird harness 100 of FIG. 1A and the bird harness 600 of FIG. 6, there may be only one clasp 906 instead of two. In other words, the first and second clasps 106A and 106B of the bird harness 100 of FIG. 1A may be replaced with the clasp 906 and/or the first and second clasps 606A and 606B of the bird harness 600 of FIG. 6 may be replaced with the clasp 906. Further by way of contrast with the bird harness 100 of FIG. 1A and the bird harness 600 of FIG. 6, straps of the bird harness 900 may go around the chest instead of the tail.

Additionally, as described above with respect to the bird harness 100, various chain and/or other portions of the bird harness 900 is covered with a cover that may be formed of fabric and/or another material. However, it is understood that this is an example. In various examples, portions of the cover may be omitted, additional cover portions may be added, and/or a different cover portion and/or portions may be used. Various configurations are possible and contemplated without departing from the scope of the present disclosure.

The barrel 922 of the clasp 906 may be similar to the barrel 222 of the clasp 606 including an internal aperture and threads facing the internal aperture.

The hook 921 of the clasp 906 may be similar to the hook 221 of the clasp 606 including a curved head end portion 924, a bent head end portion 927, a point 928, a tail end portion 923, a curved tail end portion 926, and a base portion 925. Contrasted with the hook 221 of the clasp 606, point 928 may be a first point and the tail end portion 923 may be a second point instead of a coil and/or other component that functions as a stopper. As such, links of the chain of the straps and/or other components may be slid over and/or otherwise placed onto either the point 928 and/or the tail end portion 923. Various configurations are possible and contemplated without departing from the scope of the present disclosure.

As can be seen in FIGS. 9A-9O, the point 928 may be configured to extend higher than the internal side edge of the barrel 922 that defines the internal aperture. This may result in tension that keeps the point 928 in the threads when the point 928 is within the barrel 922. This may also account for manufacturing tolerances. The point 928 may be pushed/pulled in order to get the point 928 started in the threads. This may also make the clasp 906 more challenging for a bird to undo.

FIG. 9A depicts the bird harness 900 disconnected from a bird and with the clasp 906 disassembled. The bid harness 900 includes a back strap ring 995 through which a leash portion may be pulled to create a chest strap hole.

FIGS. 9B-9E depict various views of the bird harness 900 attached to a bird 991 with the clasp 906 clasped in a front of the bird 991.

FIGS. 9F-9G depict various views of the bird harness 900 attached to the bird 991 with the clasp 906 clasped in a back of the bird 991.

FIGS. 9H-9O depict various views of assembly of the clasp 906 and attachment of the clasp 906 and/or components thereof to the bird harness 900 and/or components thereof. FIGS. 9H and 91 depict attachment of the tail end portion 923 of the hook 921 to the bird harness 900 and/or components thereof (such as a link of a chain of the straps). FIGS. 9J and 9K depict movement of the bird harness 900 and/or components thereof (such as a link of a chain of the straps) along the hook 921 towards the curved head end portion 924. FIGS. 9L-9O depict the barrel 922 being placed onto the hook 921 and movement of the barrel 922 past the tail end portion 923 and the point 928.

As shown in FIGS. 9M-9O, the tail end portion 923 and/or the point 928 may be positioned outside of the barrel 922 when the barrel 922 is attached to the hook 921. However, it is understood that this is an example. In other implementations, the tail end portion 923 and/or the point 928 may be positioned within the barrel 922 when the barrel 922 is attached to the hook 921. Various configurations are possible and contemplated without departing from the scope of the present disclosure.

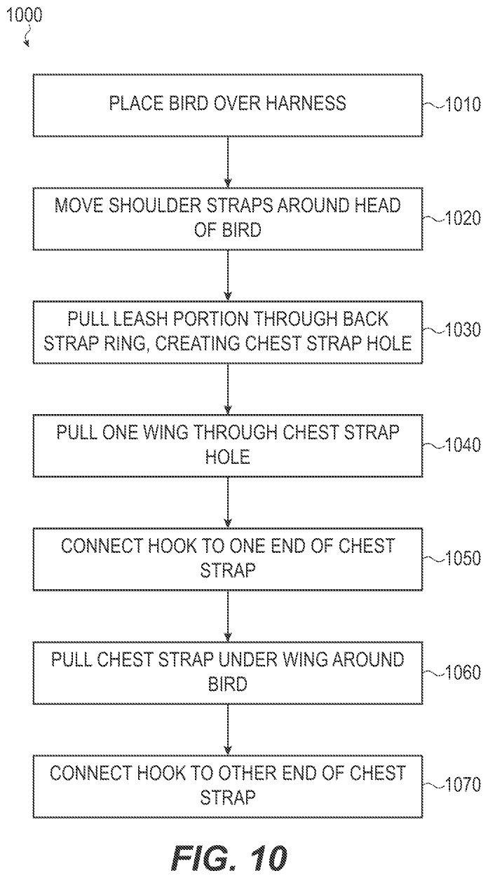

FIG. 10 depicts a flow chart illustrating a third example method 1000 for attaching a bird harness to a bird. This method 1000 may be performed using the bird harness 900 of 9A-9O.

At operation 1010, a bird may be placed over the harness. At operation 1020 the shoulder straps may be moved around head of bird. At operation 1030, a leash portion may be pulled through a back strap ring (see back strap ring 995 in FIG. 9A), creating a chest strap hole. At operation 1040 one wing may be pulled through the chest strap hole. At operation 1050 a hook of a clasp (such as the clasp 906 of 9A-9O) may be connected to one end of chest strap. At operation 1060 the chest strap may be pulled under wing around bird. At operation 1070 the hook may be connected to the other end of chest strap.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as using the clasp 906 of 9A-9O. However, this is an example. In various implementations, other clasps may be used. Various configurations are possible and contemplated without departing from the scope of the present disclosure.

In various implementations, a bird harness assembly may include a bird harness and a clasp. The bird harness may include a back strap, shoulder straps connected to the back strap, a breastbone strap connected to the shoulder straps, and a tail strap connected to the breastbone strap. The clasp may include a barrel that defines an internal aperture and includes threads facing the internal aperture and a hook. The hook may include a curved head end portion, a bent head end portion connected to the curved head end portion, a point connected to the bent head end portion, a tail end portion coupled to the tail strap, a curved tail end portion connected to the tail end portion, and a base portion connecting the curved head end portion and the curved tail end portion. The curved head end portion may be configured to connect to the bird harness when the barrel is uncoupled from the hook. The barrel may be configured to couple to the hook by screwing onto the hook while the point travels along the threads.

In some examples, at least one of the back strap, the shoulder straps, the breastbone strap, and the tail strap may be a chain. In a number of such examples, the chain may be made of steel.

In various examples, the bird harness assembly may further include a ring connected to the back strap.

In some examples, the tail end portion may be a point or a stopper.

In a number of examples, the bird harness assembly may further include a leash connected to the breastbone strap and the tail strap. In various such examples, the bird harness assembly may further include a leash loop connected to the leash.

In some implementations, a bird harness assembly may include a bird harness and a clasp, coupled to the bird harness. The clasp may include a barrel that defines an internal aperture and includes threads facing the internal aperture and a hook. The hook may include a curved head end portion, a bent head end portion connected to the curved head end portion, a point connected to the bent head end portion, a tail end portion, a curved tail end portion connected to the tail end portion, and a base portion connecting the curved head end portion and the tail end portion. The curved head end portion and the curved tail end portion may each be configured to connect to the bird harness when the barrel is uncoupled from the hook. The barrel may be configured to couple to the hook by screwing onto the hook while the point travels along the threads.

In various examples, the curved tail end portion may be configured to connect to the bird harness by connecting to a strap of the bird harness and operable to position the strap away from the threads. In some examples, the curved head end portion may cooperate with the barrel to prevent the point that is travelling along the threads from travelling all the way through the internal aperture. In a number of examples, the bent head end portion may include a bend that is positioned closer to the base portion than a first portion of the bent head end portion that connects to the curved head end portion and a second portion of the bent head end portion that connects to the point. In various examples, the hook may be formed of a unitary metal wire. In some examples, the tail end portion may resist disconnection of the bird harness from the hook other than from the point.

In a number of implementations, a clasp for a bird harness may include a barrel that defines an internal aperture and includes threads facing the internal aperture and a hook. The hook may include a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion and the curved tail end portion may each be configured to connect to the bird harness when the barrel is uncoupled from the hook. The barrel may be configured to couple to the hook by screwing onto the hook while the point travels along the threads.

In various examples, the tail end portion may be a coil or a point. In some examples, the barrel may resist removal of the bird harness from the curved head end portion and the curved tail end portion while the curved head end portion and the curved tail end portion are connected to the bird harness and the barrel is coupled to the hook. In a number of examples, the point may be operable to travel along the threads all the way through the internal aperture. In various examples, the curved head end portion may be larger than the internal aperture. In some examples, the barrel may be operable to at least partially surround the tail end portion when the barrel is coupled to the hook. In a number of examples, part of the curved head end portion may be smaller than the internal aperture.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to harnesses and/or clasps that are adjustable, durable, and resistant to manipulation by birds or other creatures upon whom the harnesses and/or clasps are used. The harness may include a number of straps (such as a back strap, shoulder straps connected to the back strap, a breastbone strap connected to the shoulder straps, and a tail strap connected to the breastbone strap) that may be formed of stainless steel chain and/or other materials and one or more clasps. The clasps may include a barrel that defines an internal aperture and includes threads facing the internal aperture and a hook that includes a curved head end portion, a bent head end portion connected to the curved head end portion, a point connected to the bent head end portion, a tail end portion, a curved tail end portion connected to the tail end portion, and a base portion connecting the curved head end portion and the curved tail end portion. The curved head end portion may be configured to connect to the harness when the barrel is uncoupled from the hook and the barrel may be configured to couple to the hook by screwing onto the hook while the point travels along the threads.

Although the above illustrates and describes a number of embodiments, it is understood that these are examples. In various implementations, various techniques of individual embodiments may be combined without departing from the scope of the present disclosure.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A bird harness assembly, comprising:
a bird harness, comprising:
a back strap;
shoulder straps connected to the back strap;
a breastbone strap connected to the shoulder straps; and
a tail strap connected to the breastbone strap; and
a clasp, comprising:
a barrel that defines an internal aperture and includes threads facing the internal aperture; and
a hook, comprising:
a curved head end portion;
a bent head end portion connected to the curved head end portion;
a point connected to the bent head end portion;
a tail end portion coupled to the tail strap;
a curved tail end portion connected to the tail end portion; and
a base portion connecting the curved head end portion and the curved tail end portion; wherein:
the curved head end portion is configured to connect to the bird harness when the barrel is uncoupled from the hook; and
the barrel is configured to couple to the hook by screwing onto the hook while the point travels along the threads.

2. The bird harness assembly of claim 1, wherein at least one of the back strap, the shoulder straps, the breastbone strap, and the tail strap comprises a chain.

3. The bird harness assembly of claim 2, wherein the chain is made of steel.

4. The bird harness assembly of claim 1, further comprising a ring connected to the back strap.

5. The bird harness assembly of claim 1, wherein the tail end portion is a point or a stopper.

6. The bird harness assembly of claim 1, further comprising a leash connected to the breastbone strap and the tail strap.

7. The bird harness assembly of claim 6, further comprising a leash loop connected to the leash.

8. A bird harness assembly, comprising:
a bird harness; and
a clasp, coupled to the bird harness, comprising:
a barrel that defines an internal aperture and includes threads facing the internal aperture; and
a hook, comprising:
a curved head end portion;
a bent head end portion connected to the curved head end portion;
a point connected to the bent head end portion;
a tail end portion;
a curved tail end portion connected to the tail end portion; and
a base portion connecting the curved head end portion and the tail end portion; wherein:
the curved head end portion and the curved tail end portion are each configured to connect to the bird harness when the barrel is uncoupled from the hook; and
the barrel is configured to couple to the hook by screwing onto the hook while the point travels along the threads.

9. The bird harness assembly of claim 8, wherein the curved tail end portion is:
configured to connect to the bird harness by connecting to a strap of the bird harness; and
operable to position the strap away from the threads.

10. The bird harness assembly of claim 8, wherein the curved head end portion cooperates with the barrel to prevent the point that is travelling along the threads from travelling all the way through the internal aperture.

11. The bird harness assembly of claim 8, wherein the bent head end portion includes a bend that is positioned closer to the base portion than a first portion of the bent head end portion that connects to the curved head end portion and a second portion of the bent head end portion that connects to the point.

12. The bird harness assembly of claim 8, wherein the hook is formed of a unitary metal wire.

13. The bird harness assembly of claim 8, wherein the tail end portion resists disconnection of the bird harness from the hook other than from the point.

14. A clasp for a bird harness, comprising:
a barrel that defines an internal aperture and includes threads facing the internal aperture; and
a hook, comprising:
a curved head end portion;
a bent head end portion connected to the curved head end portion;
a point connected to the bent head end portion;
a tail end portion;
a curved tail end portion connected to the tail end portion; and
a base portion connecting the curved head end portion and the curved tail end portion; wherein:
the curved head end portion and the curved tail end portion are each configured to connect to the bird harness when the barrel is uncoupled from the hook; and
the barrel is configured to couple to the hook by screwing onto the hook while the point travels along the threads.

15. The clasp of claim 14, wherein the tail end portion comprises a coil or a point.

16. The clasp of claim 14, wherein the barrel resists removal of the bird harness from the curved head end portion and the curved tail end portion while the curved head end portion and the curved tail end portion are connected to the bird harness and the barrel is coupled to the hook.

17. The clasp of claim 14, wherein the point is operable to travel along the threads all the way through the internal aperture.

18. The clasp of claim 14, wherein the curved head end portion is larger than the internal aperture.

19. The clasp of claim 14, wherein the barrel is operable to at least partially surround the tail end portion when the barrel is coupled to the hook.

20. The clasp of claim 14, wherein part of the curved head end portion is smaller than the internal aperture.
